(19) United States
(12) Patent Application Publication
(10) Pub. No.: US 2008/0006155 A1
(43) Pub. Date: Jan. 10, 2008

(54) Particulate filter cleaning device

(76) Inventors: Cheryl L. Sellers, Peoria, IL (US); Jade M. Katinas, Chillicothe, IL (US); David W. Painter, Wyoming, IL (US)

Correspondence Address: Caterpillar Inc.;Intellectual Property Dept., AB 6490, 100 N.E. Adams Street, PEORIA, IL, 61629-6490, US

(21) Appl. No.: 11/483,230

(22) Filed: Jul. 7, 2006

(51) Int. Cl. B01D 46/00

(52) U.S. Cl. 95/282; 55/295; 55/289

(57) ABSTRACT

A method for cleaning a diesel particulate filter by loosening and removing ash from a filter passage in a diesel particulate filter. The steps include providing a diesel particulate filter containing ash within the filter passages, providing a particulate filter cleaning device, and inserting the particulate filter cleaning device into the filter passages. The steps also include moving the particulate filter cleaning device within the filter passage to loosen the ash particles, removing the particulate filter cleaning device from the filter passage, and removing the loosened ash particles from the filter.

### TECHNICAL FIELD

The present disclosure relates generally to a device for cleaning a diesel particulate filter and more particularly to a device that is adapted to remove sintered ash particles from the filter.

### BACKGROUND

Engines, including diesel engines, gasoline engines, natural gas engines, and other engines known in the art may exhaust a complex mixture of pollutants. The pollutants may be composed of gaseous and solid materials, including particulate matter, nitrogen oxides (“NOx”), and sulfur compounds.

Due to heightened environmental concerns, engine exhaust emission standards have become increasingly stringent over the years. The amount of pollutants emitted from an engine are regulated based on the type, size, and class of engine. One method that has been implemented by engine manufacturers to comply with the regulation of particulate matter, NOx, and sulfur compounds exhausted to the environment has been to remove these pollutants from the exhaust flow of an engine with filters. However, extended use and repeated regeneration of such filters may cause the pollutants to build up in the components or on the components of the filters, thereby causing filter functionality and engine performance to decrease.

The desire to construct or design a “cleanable” particulate filter for diesel engines has been present for several years. One development reported in 1995 by the Karlsruhe Research Center of Germany includes the use of a metal fiber material in a form referred to as a “filter candle”. As reported, particulate filters for diesel engines must be regenerated at regular intervals in order to keep the exhaust gas backpressure that rises with increasing particulate loading of the filter within tolerable limits. The particulates are removed from the filter by electric heating under excess air conditions that burn a majority of the particulates to carbon dioxide (CO.sub.2).

Compared to “cleanable” filter designs, the reported electric heating approach is substantially more complicated and costly. In order to meet the particulate levels legislated by EPA regulations, the use of particulate filters will likely be necessary. As noted, these particulate filters are used to collect and oxidize carbonaceous and hydrocarbon compounds that make up particulate emissions. Over a period of time, the filter also collects the residuals of the oxidation by-products in the form of ash or other deposits that are not combustible. The ash deposits collect in the filter channels, resulting in blockages that will not allow the exhaust gases to pass through the filter. The blockages result in excessive exhaust back pressure that reduces engine performance and can lead to engine shutdown. Testing has shown that as the test time increased, the pressure drop across the ceramic filters (cordierite) increased even after the combustible carbon particles were burned. Further investigation showed that the non-combustible materials that remained were ash deposits.

One method of removing built-up pollutants from a filter may be to remove the clogged filter from the machine to which it is connected and direct a flow of gas through the filter in a direction that is opposite the direction of normal flow. The filter may be large, heavy, and difficult to disconnect, making it cumbersome, time consuming, and dangerous to remove the filter from the engine of the work machine for servicing.

Another method of removing matter from a filter may be to divert an exhaust flow from the clogged filter to a separate filter, without disconnecting either filter from the engine. While the exhaust flow is diverted, air may be directed through the clogged filter in a direction opposite the normal flow. Since such matter removal systems include a second filter, however, they may be larger and more costly than single filter systems.

U.S. Pat. No. 5,566,545 (“the '545 patent”) teaches a system for removing particulate matter from an engine filter. In particular, the '545 patent discloses a filter connected to an engine exhaust line, a valve structure within the exhaust line, and an air feeder. When air is supplied to the filter in a reverse flow direction, the air may remove captured particulates from the filter. Although the '545 patent may teach the removal of matter from a filter, the system described therein requires the use of a second filter during a reverse flow condition, thereby increasing the overall cost and size of the system. Moreover, the system is not capable of supplying a negative pressure to the filter to assist in the filter cleaning process. This is just one of many mechanisms known to aid in the removal of ash from a filter. Another example of a filter cleaning apparatus using forced air flow is shown in U.S. Pat. No. 7,025,811.

Regardless of the method used to remove ash from a filter, some ash particles remain within the filter and become sintered together or to the filter. Sintering is the fusion of combustion byproduct particles on filter surfaces as a result of the heat in that filter. If temperatures during uncontrolled regenerations are sufficiently high, the ash can sinter to the filter passages and substrates, or can even react with the filter resulting in partial melting of the filter. Therefore, it is important to remove as much of the ash particles as possible using any suitable method. Once the ash has become sintered, however, other mechanisms for removing the sintered ash are required since vacuums and shake out devices are less effective in doing so.

The present invention is directed to overcoming one or more of the issues set forth above.

### SUMMARY OF THE INVENTION

In one aspect of the disclosure, a method for cleaning a diesel particulate filter is disclosed. In particular, the method is for removing ash from a filter passage in a diesel particulate filter. The steps include providing a diesel particulate filter containing ash within the filter passages, providing a particulate filter cleaning device and inserting the particulate filter cleaning device into the filter passage formed in the filter. The method also includes moving the particulate filter cleaning device within the filter passage to loosen the ash particles, removing the particulate filter cleaning device from the filter passage, and removing the loosened ash particles from the filter.

In another aspect of the disclosure, a particulate filter cleaning device for removing ash from a filter passage of a diesel particulate filter is disclosed. The device includes a handle portion and at least one brush portion extending from the handle portion. The brush portion includes a plurality of bristles, and the brush portion is configured to fit within the filter passage of the diesel particulate filter such that the bristles move against walls of the filter passage to loosen and remove ash from the filter passage.

### BRIEF DESCRIPTION OF THE DRAWINGS

FIG. 1 is a diagrammatic illustration of a service system connected to a diesel particulate filter.

FIG. 2 is a perspective view of a portion of a particulate filter cleaning device according to an embodiment of the invention.

FIG. 3 is a perspective view of a portion of a particulate filter cleaning device according to an alternate embodiment of the invention.

FIG. 4 is a perspective view of a portion of a particulate filter cleaning device according to an alternate embodiment of the invention.

FIG. 5 is a perspective view of a portion of a particulate filter cleaning device according to an alternate embodiment of the invention.

FIG. 6 is a perspective view of a portion of a particulate filter cleaning device according to an alternate embodiment of the invention.

FIG. 7 is a partial sectional view of a diesel particulate filter and a filter cleaning device.

FIG. 8 is a partial sectional view of the diesel particulate filter and filter cleaning device of FIG. 7 illustrating a method of cleaning a diesel particulate filter using the particulate filter cleaning device.

### DETAILED DESCRIPTION

Exemplary embodiments of the present disclosure are illustrated in the accompanying drawings. Wherever possible, the same reference numbers will be used throughout the drawings to refer to the same or like parts.

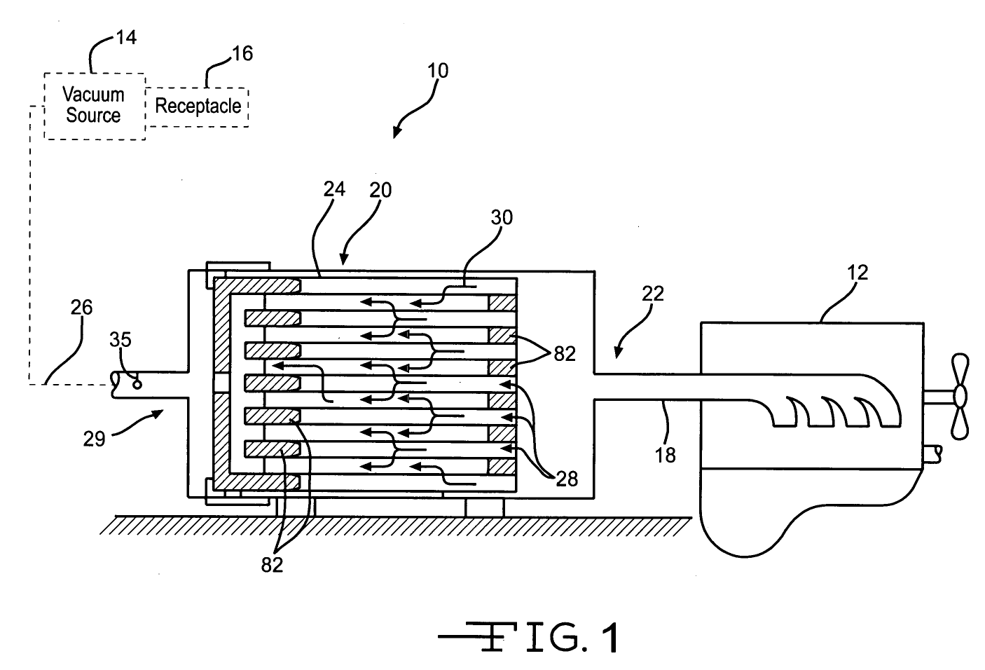

FIG. 1 illustrates an example of one type of a diesel particulate filter service system connected to a diesel particulate filter (also known as a DPF) 20. As shown, the service system, such as an ash removal apparatus 10, may further include at least one of a receptacle 16, a matter removal line 26, and a vacuum source 14. Components of the ash removal apparatus 10 may be operatively attached to the diesel particulate filter 20 for service and may be removed from the diesel particulate filter 20 when service is complete. A user may operatively attach and remove components of the ash removal apparatus 10 and may service the diesel particulate filter 20 without removing the diesel particulate filter 20 from the machine, vehicle, or other device to which the diesel particulate filter 20 is attached. As used herein, the term “machine” may include on-road vehicles, off-road vehicles, and stationary machines, such as, for example, generators and other exhaust-producing devices.

As shown in FIG. 1, the diesel particulate filter 20 is connected to an internal combustion engine 12, such as, for example, a diesel engine. The engine 12 may include an exhaust line 18 connecting an exhaust flow of the engine 12 with an inlet end 22 of the diesel particulate filter 20. The engine 12 may also include a turbo (not shown) connected to the exhaust line 18. In such an embodiment, the inlet end 22 of the diesel particulate filter 20 may be connected to an outlet of the turbo. The diesel particulate filter 20 may also be configured in any airflow stream other than that which is shown.

One or more machine diagnostic devices 35 may be disposed proximate an outlet end 29 of the diesel particulate filter 20. The machine diagnostic devices 35 may be, for example, part of the work machine or other device to which the diesel particulate filter 20 is connected and may be external to the diesel particulate filter 20. Alternatively, the machine diagnostic devices 35 may be internal to the diesel particulate filter 20. Machine diagnostic devices 35 may be any sensing devices known in the art, such as, for example, flow meters, emission meters, pressure transducers, radio devices, or other sensors. Such machine diagnostic devices 35 may sense, for example, an increase in the levels of soot, NOx, or other pollutants leaving the diesel particulate filter 20. The machine diagnostic devices 35 may send pollutant-level information to a controller or other device (not shown) and may assist in, for example, triggering diesel particulate filter regeneration and diesel particulate filter servicing indicator.

The diesel particulate filter 20 may be any type of particulate filter, such as, for example, a foam cordierite, sintered metal, or silicon carbide type filter. As illustrated in FIG. 1, the diesel particulate filter 20 may include filter media 24. The filter media 24 may include any material useful in removing pollutants from an exhaust flow. In an embodiment of the present disclosure, the filter media 24 may contain catalyst materials capable of collecting, for example, soot, NOx, sulfur compounds, particulate matter, and other pollutants known in the art. Such catalyst materials may include, for example, alumina, platinum, rhodium, barium, cerium, and alkali metals, alkaline-earth metals, rare-earth metals, or combinations thereof. The filter media 24 may be situated horizontally (as shown in FIG. 1), vertically, radially, or helically. The filter media 24 may also be situated in a honeycomb, mesh, or any other configuration so as to maximize the surface area available for the filtering of pollutants.

For the purposes described herein, the filter media 24 defines a plurality of filter passages 28. The filter passages 28 may be arranged in any suitable configuration. For example, the filter passages 28 may be substantially parallel channels extending in an axial direction. The filter passages 28 may be, for example, flat, cylindrical, oval, square tube-shaped, or have any other shape. The filter passages 28 may have desired porosities and other characteristics based on the catalyst materials of the filter media 24, and may be configured to allow, for example, gases to pass between adjacent filter passages 28 while substantially restricting the passage of pollutants and particles. For example, exhaust gases and air may pass between adjacent filter passages 28 while the passage of soot, NOx, sulfur compounds, particulate matter, and other pollutants therebetween may be substantially restricted. The arrows 30 in FIG. 1 illustrate the flow of such gases in a normal flow direction between adjacent filter passages 28. The general operation of the diesel particulate filter 20 is known or can be easily understood by one skilled in the art.

During operation of the engine 12, soot is collected within the diesel particulate filter 20. Extended use and repeated regeneration of such filters may cause the pollutants to build up in the components of the filters, thereby causing filter functionality and engine performance to decrease. Particularly, materials that do not combust during regeneration remain as ash deposits within the diesel particulate filter 20. During subsequent regeneration or other heating of the filter, ash particles that remain within the filter can become sintered together or to the filter. Sintering is the fusion of combustion byproduct particles on filter surfaces as a result of the heat in that filter. If temperatures during uncontrolled regenerations are sufficiently high, the ash can sinter to the filter or even react with the filter resulting in partial filter melting. Once the ash has become sintered, other mechanisms for removing the sintered ash particles are required since fluid flow or other systems do not easily remove the sintered ash particles.

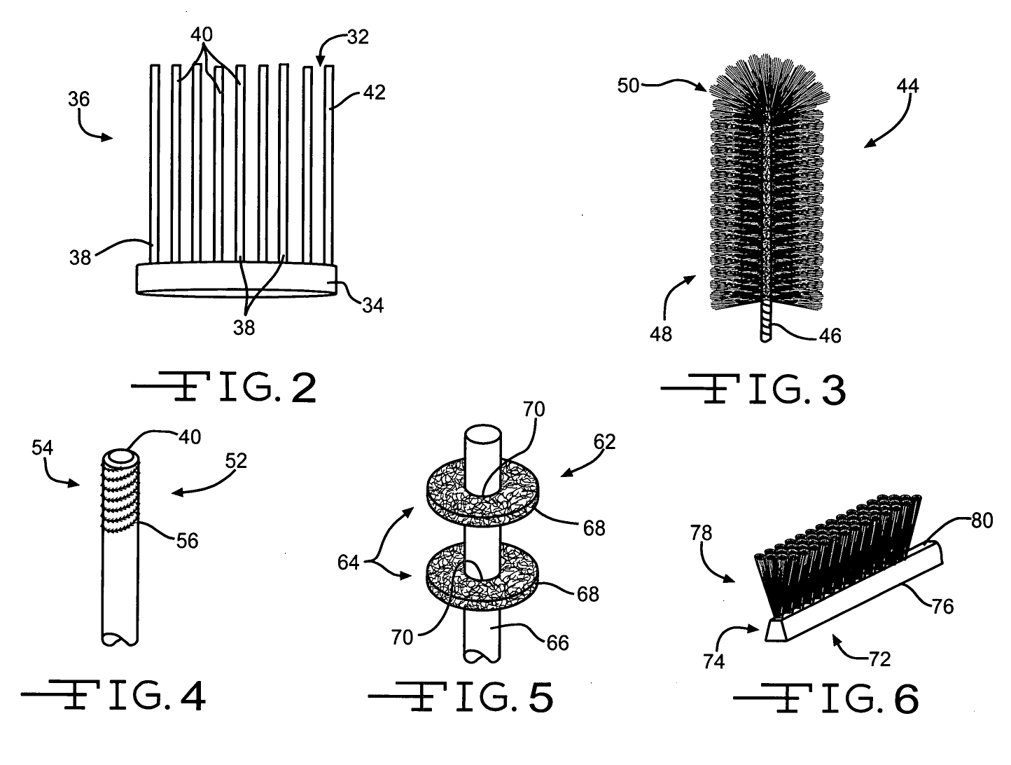

There is illustrated in FIG. 2, a perspective view of a particulate filter cleaning device, indicated generally at 32 for use with the diesel particulate filter 20 shown above. The device 32 includes a handle portion 34 and a brush portion 36. The brush portion 36 includes an arm 42 having a proximal end 38 connected to the handle portion 34 and a distal end 40 extending away from the handle portion 34. The proximal end 38 can be connected to the handle portion 34 in any suitable manner. Each arm 42 can be releasably connected to the handle portion 34, if it is so desired, to allow for the replacement of each brush portion 36 due to wear, damage, for cleaning, or for any other reason. The device 32 is shown as having a plurality of brush portions 36. However, it can be appreciated that the device can include a single brush portion 36 if it is so desired. As will be described in greater detail below, the distal end 40 of the arm 42 has a plurality of bristles (shown in detail in FIGS. 3-6) extending from the arm 42. It should also be appreciated that the handle portion 34 can have any suitable shape, size and configuration so as to facilitate the operation of the particulate filter cleaning device, as will be described in greater detail below.

Illustrated in FIG. 3 is an example of a “wire” brush particulate filter cleaning device 44. Particularly, a perspective view of a portion of a brush portion 48 is shown. The device 44 can also be referred to as a “side-action” brush and is similar in configuration to a test tube cleaning brush. The brush portion 48 includes an arm 46 and a plurality of bristles 50 extending from the brush portion 48. The arm 46 is shown as being substantially straight. However, it can be appreciated that the arm 46 could be angled, bent or otherwise oriented depending on the required design criteria. The arm 46 is made of a substantially rigid material such as from metal, plastic, or a composite. It is preferred that the arm 46 is made of a material that will not scratch the diesel particulate filter 20 when the diesel particulate filter 20 is being cleaned due to the material, integrity requirements, and cost of the diesel particulate filter 20.

Although the device 44 is referred to as a wire brush particulate filter cleaning device 44, it can be appreciated that the term “wire” is meant to include any type of brush bristle. The bristles 50 of the illustrated embodiment are made from any one of, or a combination of, horsehair, bristle, wire, metal filaments, tampico, and polymeric material fibers such as nylon or polypropylene. The bristles 50 of the brush portion 48 can be oriented in any suitable manner to maximize the cleaning effectiveness of the device 44. For example, the bristles 50 can have a blunt or round tip design with a substantially smooth or rounded contact surface, tip or end. This design ensures there are no sharp edges to scratch the item being cleaned. Alternatively, the bristles 50 can have a fan tip design so that the bristles 50 can more easily enter the narrow filter passages 28 and then expand to clean the sides of the filter passages 28 while protecting the end of the filter from scratches from a wire tip. Alternatively, the bristles 50 can have a radial tip or double fan tip design. This design includes formed brush sprays at the tip of the brush portion 48. This allows the device 44 to thoroughly clean the sides of the diesel particulate filter 20 without scratching it. The bristles 50 can also have a straight or cut-off tip design. With this design, the bristles 50 are trimmed of excess wire at the distal end 40 of the brush portion 48. This type of tip could be useful since the filter passages 28 are substantially open-ended. Finally, the bristles 50 could have a tied tip design where a second bristle material is tied around the first bristle material. This aids in the cleaning of corners and bottom channel of filter passages 28, while protecting the filter passages 28 and the diesel particulate filter 20 from being scratched.

Although only a single configuration of bristles 50 on the arm 46 is shown in FIG. 3, it can be appreciated that the device 44 can have any suitable bristle design and configuration. For example, the brush portion 48 can have a crimped wire end design, a crimped wire internal brush design, a spiral tube configuration, a helix strip brush design, or a strip brush design. One skilled in the art would understand how to make and use these configurations, as well as other bristle configurations not specifically listed, in accordance with the disclosures made herein.

Illustrated in FIG. 4 is a perspective view of a brush portion 52 of a particulate filter cleaning device 54 according to an alternate embodiment of the invention. The brush portion 52 includes an arm 58 and a plurality of bristles 60. In the illustrated embodiment, a groove 56 (or a plurality of grooves) is formed along the length of the arm 58. Alternatively, the groove 56 can extend along only a portion of the length of the arm 58. As shown, the groove 56 is helical but it can be appreciated that a plurality of circumferential grooves, or grooves having any other configuration, could also be used to accomplish the same purpose. Extending from the helical groove 56 is the plurality of bristles 60. The bristles 60 can be made of any suitable material, as was described above. The bristles 60 are shown as being wound into the helical groove 56. However, the bristles 60 can be attached to the groove 56 in any suitable manner. As is also illustrated in FIG. 4, the distal end 40 of the arm 58 is heavily tufted with bristles 60 to improve the cleaning capability thereof.

Illustrated in FIG. 5 is a perspective view of a brush portion 64 of a particulate filter cleaning device 62 according to an alternate embodiment of the invention. The brush portion 64 includes an arm 66 and a pair of wheel bristle brushes 68. Any number of wheel bristle brushes 68 can be connected to the arm 66, or a single longitudinally extending wheel bristle brushes (not shown) can be used in accordance with this embodiment of the invention. The wheel bristle brushes 68 can be made of any suitable material, as was described above. The wheel bristle brushes 68 are shown as being connected to a center ring 70, which in turn is connected to the arm 66. The center ring 70 includes a pair of rings that are crimped, or otherwise held together, to secure individual bristles to the center ring 70. However, the wheel bristle brushes 68 can be connected to, and extend directly from, the arm 66 if it is so desired. The wheel bristle brushes 68 can have any diameter, or variable diameters, but are preferably sized and shaped to fit within and engage the sides of the filter passages 28, as will be described in greater detail below.

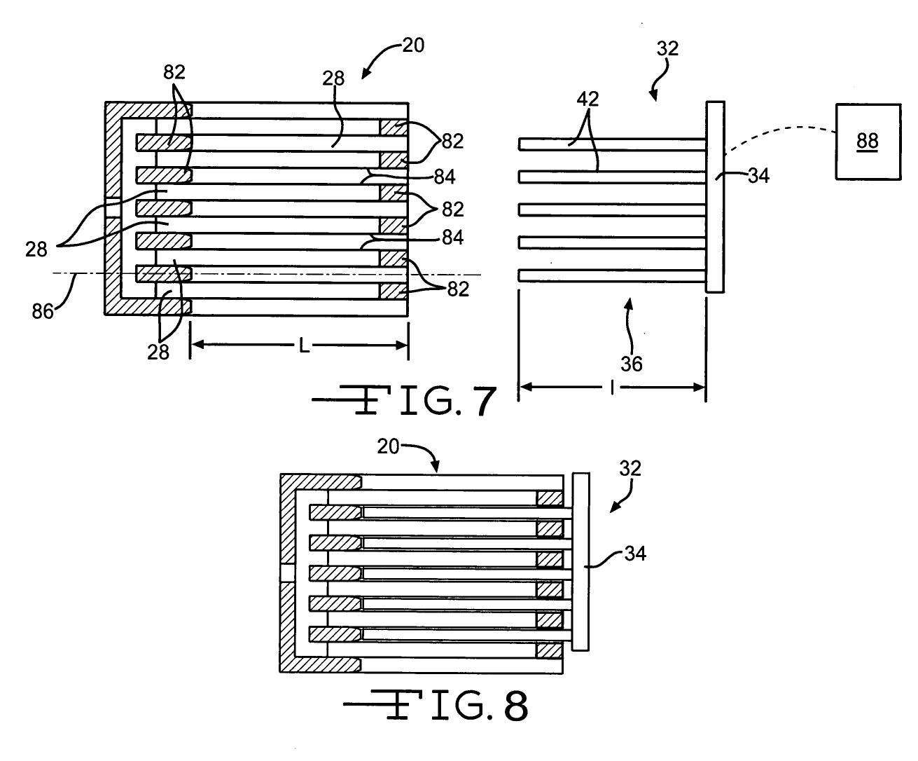

Illustrated in FIG. 6 is a perspective view of a brush portion 74 of a particulate filter cleaning device 72 according to an alternate embodiment of the invention. The brush portion 74 includes an arm 76 and a plurality of bristles 78. In the illustrated embodiment, the bristles 78 are connected to, and extend from at least one face 80 of the arm 76. As such, the structure of the device 72 is similar to that of a toothbrush. However, as can be seen, the bristles 78 are of varying lengths, and have a flared out orientation. Such a design allows a larger and wider area to be cleaned by the bristles 78 when the device 72 is being operated. Alternatively, the bristles 78 could extend from multiple faces of the arm 76 if desired. As with the above embodiments, the bristles 78 can be made of any suitable material and can be connected to the arm 76 in any suitable manner. Additionally, the bristles 78 can extend along a portion of, or the entire length of, the arm 76.

### INDUSTRIAL APPLICABILITY

Illustrated in FIG. 7 is a sectional view of the diesel particulate filter 20 that was shown in FIG. 1. The diesel particulate filter 20 is shown separate from the ash removal apparatus 10 shown in FIG. 1 for the sake of clarity. As can be seen in FIG. 7, some of the filter passages 28, alternating passages as illustrated, are blocked by a blocking mechanism 82. The blocking mechanism 82 is typically used with a diesel particulate filter 20 that has a wall flow-through design. In a wall flow-through design, air enters the filter passage 28, but due to the presence of the blocking mechanism 82, the air is substantially blocked from passing completely through that filter passage 28 and from exiting the diesel particulate filter 20. Therefore, the air must flow through the walls of the filter passages 28 in order to exit the diesel particulate filter 20 (as shown by the arrows 30 in FIG. 1). As the air flows through the walls of the filter passages 28, the filter materials trap particulates from the air.

Also shown in FIG. 7 is a particulate filter cleaning device 32. It can be appreciated that any of the particulate filter cleaning devices shown and described above can be used with any diesel particulate filter. However, only the cleaning device 32 is discussed in this section, for use with the diesel particulate filter 20, for the sake of simplicity. As shown, the device 32 has a handle portion 34 which a user can grasp to maneuver the device 32 and use the device 32 to remove ash from the filter passages 28 of the diesel particulate filter 20. As shown in FIG. 7, the brush portions 36 of the device 32 include a plurality of arms 42. The arms 42 are sized and shaped to fit within the filter passages 28 to effect the removal of ash therefrom.

As can be seen in FIG. 8, the brush portions 36 of the device 32 have been inserted into the filter passages 28. As the brush portions 36 are inserted into the filter passages 28, the bristles (not shown in this view) contact the inner surfaces 84 of the filter passages 28. By moving the device 32 in and out of the filter passages 28, ash particles that are sintered to the inner surfaces 84 will be loosened and separated from those surfaces 84. It can be appreciated that the device 32 can be moved in and out of the filter passages along the axis 86 of the filter passages 28, at an angle to the axis 86 of the filter passages 28, and rotated within the filter passages 28.

It is anticipated that the arms 42 of the device 32 are made of a semi-flexible material such that the brush portion 36 can be moved within the filter passages 28 without breaking the arm 42. However, the arm 42 is also sufficiently rigid such that the bristles can be pressed against the inner surfaces 84 of the filter passages 28 with some degree of pressure and without the arm 42 flexing. If the arm 42 were to flex an excessive amount, it is possible that the effectiveness of the bristles acting in a brushing manner against the inner surfaces 84 of the filter passages 28 might be reduced.

The filter cleaning device 32 can be sized and shaped so that the number of brush portions 36 corresponds to the number of filter passages 28 formed in the diesel particulate filter 20. Therefore, each brush portion 36 could be inserted into each of the filter passages 28 substantially simultaneously. The device 32 could also have one-half the number of brush portions 36 as the number of filter passages 28 so that half the filter passages 28 can be simultaneously “brushed” with the filter cleaning device 32. Such a configuration can be useful if supplementing the brushing and cleaning process with the introduction of an air flow to facilitate the ash particle removal. Such a configuration could also be useful if cleaning the filter passages 28 from a first side and then from a second side, since in the illustrated embodiment, approximately one-half of the filter passages 28 are blocked at their respective ends when looking at the filter end-on. Therefore, as viewed from the opposite side, the opposite filter passages 28 would be blocked.

It can also be appreciated that the length, l, of the arms 42, of the device 32 can be substantially the same as the length, L, of the filter passages 28, or longer than the length, L, of the filter passages 28. It is preferred that the length, l, of the arms 42 is at least one-half the length, L, of each filter passage 28 so that the device 32 could be inserted from either side of the diesel particulate filter 20 and still be able to reach beyond a mid-point of the filter passage 28. Thus, if the device 32 were inserted from both ends of the diesel particulate filter 20 to clean the filter passage 28, the entire length, L, of the filter passage 28 would be contacted by the device 32.

According to an alternate embodiment of the invention, the operation of the filter cleaning device 32 to “brush” the inner surfaces 84 of the filter passages 28 can be done manually, as described above. Additionally, or alternatively, the operation of the device can be automated. Schematically shown in FIG. 7 is a filter cleaning device moving mechanism 88. The moving mechanism 88 can be directly coupled to the device 32, or can be electronically (or otherwise) connected to the device 32. The moving mechanism 88 can use actuators and reciprocating arms (not shown) to grasp the device 32, insert and retract the device 32 from the diesel particulate filter 20, and move the device 32 when it is positioned within the diesel particulate filter 20 to loosen the ash particles from the filter passages 28. The moving mechanism 88 can also include mechanisms that enable the entire device 32 to rotate, or can include mechanisms that allow the individual brush portions 36 to rotate. Any of the brush portions described above could be rotated in this manner. The moving mechanism 88 can be designed such that the device 32, or any separate portion thereof (the brush portions 36, the arms 42, and the bristles) can be made to rotate, articulate, spin, and reciprocate, in order to facilitate the loosening and removal of the ash particles from the diesel particulate filter 20.

In addition, the diesel particulate filter ash removal apparatus 10 described above can be operated in conjunction with the operation of the device 32 to facilitate the removal of the ash particles from the diesel particulate filter 20. The operation of the ash removal apparatus 10 can occur prior to the operation of the device 32, after the operation of the device 32, or substantially simultaneously with the operation of the device 32. In addition, the ash removal apparatus 10 could be operated before, during and after the operation of the device 32 if it is so desired. The utility of doing so is such that the ash removal apparatus 10 can facilitate the removal of the loosened ash particles by directing air through the filter passages 28. Alternatively, once the device 32 has been used, the ash particles can be shaken out using an ash shake-out machine, vacuumed out using an ash vacuum machine, and forced out using a forced air flow machine, or otherwise removed from the diesel particulate filter 20 by any suitable method or mechanism. One or more mechanisms that implement different methods or mechanism for removing the loosened ash from the diesel particulate filter 20 could also be used, if it is so desired. Each of these mechanism is represented at least schematically by the ash removal apparatus 10 shown in FIG. 1.

It should be appreciated that the device 32, and any of the embodiments of the device shown and described above, could be used while the diesel particulate filter 20 is connected to the machine, vehicle, or other device in which the diesel particulate filter 20 is installed. There may be some adjustments that are made to the vehicles and machines in order to gain access to the diesel particulate filter 20, as would be apparent to one skilled in the art.

It should be understood that the above description is intended for illustrative purposes only, and is not intended to limit the scope of the present disclosure in any way. Thus, those skilled in the art will appreciate that other aspects, objects, and advantages of the disclosure can be obtained from a study of the drawings, the disclosure and the appended claims.

What is claimed is:

1. A method for removing ash from a filter passage in a diesel particulate filter comprising:
providing the diesel particulate filter with the filter passage formed therein, the filter having ash particles contained within the filter passage;
providing a particulate filter cleaning device;
inserting the particulate filter cleaning device into the filter passage formed in the filter;
moving the particulate filter cleaning device within the filter passage to loosen the ash particles;
removing the particulate filter cleaning device from the filter passage; and
removing the loosened ash particles from the filter.

2. The method defined in claim 1 wherein the particulate filter cleaning device includes a handle portion and a brush portion;
wherein the brush portion extends from the handle portion; and
the brush portion has an arm and a plurality of bristles projecting from the arm.

3. The method defined in claim 1 further comprising the step of providing an ash removal apparatus, the apparatus being one of an ash vacuum machine, an ash shake-out machine, and a forced air flow machine; and
operating one or more of the ash removal apparatuses to remove the loosened ash particles from the filter.

4. The method defined in claim 3 wherein the step of operating the ash removal apparatus is done before the step of inserting the particulate filter cleaning device into the filter.

5. The method defined in claim 3 wherein the step of operating the ash removal apparatus is done after the step of removing the particulate filter cleaning device from the filter.

6. The method defined in claim 3 wherein the step of operating the ash removal apparatus is done before the step of inserting the particulate filter cleaning device into the filter and after the step of removing the particulate filter cleaning device from the filter.

7. The method defined in claim 3 wherein the step of operating the ash removal apparatus is done substantially simultaneously with at least one of the steps of inserting the particulate filter cleaning device into the filter and removing the particulate filter cleaning device from the filter.

8. The method defined in claim 1 wherein the step of moving the particulate filter cleaning device within the filter passage to loosen the ash particles includes at least one of moving the particulate filter cleaning device along an axis of the filter passage, moving the particulate filter cleaning device at an angle to the axis of the filter passage, and rotating the particulate filter cleaning device within the filter passage.

9. The method defined in claim 8 wherein the step of moving the particulate filter cleaning device within the filter passage is performed by a particulate filter cleaning device moving mechanism.

10. The method defined in claim 9 wherein the particulate filter cleaning device moving mechanism is automated.

11. The method defined in claim 10 wherein the particulate filter cleaning device moving mechanism operates to at least one of rotate, articulate, spin, and reciprocate the brush portion within the filter passage.

12. A particulate filter cleaning device for loosening ash from a filter passage of a diesel particulate filter comprising:
a handle portion; and
at least one brush portion extending from the handle portion;
wherein the brush portion includes a plurality of bristles, and the brush portion is configured to fit within the filter passage of the diesel particulate filter such that the bristles move against the filter passage to loosen ash within the filter passage.

13. The device defined in claim 12 further including a plurality of brush portions, wherein each brush portion is configured to be inserted into one of a plurality of filter passages.

14. The device defined in claim 12 wherein the bristles are made from at least one of horsehair, nylon, a polymeric material, and wire.

15. The device defined in claim 12 wherein the bristles are secured to the brush portion and the bristles have a substantially smooth contact surface.

16. The device defined in claim 12 wherein the brush portion is heavily tufted with bristles at a distal end of the brush portion.

17. The device defined in claim 12 wherein the brush portion has a distal end having grooves formed therein; and
wherein the bristles are wound into the grooves.

18. The device defined in claim 12 wherein the bristles are chemically resistant.

19. The device defined in claim 12 wherein the brush portion has a length that is at least as long as ½ the length of the filter passage.

20. The device defined in claim 19 wherein the plurality of bristles extend along the length of the brush portion that is equal to about ½ the length of the filter passage.
